(19) United States
(12) Patent Application Publication
(10) Pub. No.: US 2021/0208352 A1
(43) Pub. Date: Jul. 8, 2021

(54) OPTICAL FIBERS AND CABLES FOR HIGH TEMPERATURE APPLICATIONS

(71) Applicant: AFL Telecommunications LLC, Duncan, SC (US)

(72) Inventors: Jarrett Shinoski, Greenville, SC (US); Sean Foley, Simpsonville, SC (US); William Paul Jacobsen, Bolton, CT (US); Brett Villiger, Simpsonville, SC (US)

(21) Appl. No.: 16/732,884

(22) Filed: Jan. 2, 2020

(51) Int. Cl. G02B 6/44

(52) U.S. Cl. CPC G02B 6/443

(57) ABSTRACT

Optical fibers and optical fiber cables for use in high temperature applications are provided. An optical fiber for use in high-temperature applications includes a core, a cladding surrounding the core, a metal coating surrounding the cladding, and a barrier layer surrounding and in direct contact with the metal coating. The barrier layer may include a boron nitride lubricant, the barrier layer being a dried film on the metal coating, in exemplary embodiments having a thickness of between 2 microns and 20 microns. Alternatively, the barrier layer may include a synthetic metallic grease, the synthetic metallic grease in exemplary embodiments having a thickness of between 20 microns and 200 microns.

### FIELD

The present disclosure relates generally to optical fibers and optical fiber cables, and more particularly to optical fibers and optical fiber cables for use in high temperature applications such as those above 300 degrees Celsius.

### BACKGROUND

Optical fiber cables which include one or more optical fibers in a metallic tube (such as a stainless steel tube) are utilized in a variety of applications. One specific application is the use of such cables in harsh environmental applications. For example, such cables may be utilized as downhole cables for oil and gas fields and/or geothermal wells. Fibers within these environments measure various parameters such as temperature, pressure, strain, flow, seismic and acoustic waves.

Many such harsh environmental applications involve high temperature environments, generally at least above 300 degrees Celsius (CC). In such environments, the optical fibers themselves include a metal coating. This metal coating is used in place of the typical polymeric coating for high temperature situations. Both act as a protective layer over the glass cladding, but the metal coating is capable of withstanding elevated temperatures. However, the use of metal-coated optical fibers in metallic tubes at such high-temperatures can be problematic. For example, sustained high temperatures (e.g., a range of 500° C.-600° C.) can result in inter-diffusion of the metallic tube and the metal coating of the optical fibers. As a result, the metal-coated optical fibers may bond to the metallic tubes. In the case of multiple optical fibers in a metallic tube, the fibers may also stick to each other. This fusing phenomenon causes increased optical losses and fiber breakages.

Various solutions to the above-identified issue have been attempted. For example, certain talc materials and gel materials have been applied to the metal-coated optical fibers and metallic tubes. However, gel materials cannot survive temperatures in excess of 300° C., much less above 500° C.-600° C. Talc can be easily and inadvertently removed after application by simple contact with the optical fibers or metallic tubes, and is an airborne particulate that could negatively affect other steps in the optical fiber and cable forming process, such as welding steps.

Accordingly, improved optical fibers and optical fiber cables for use in high-temperature environments are desired. In particular, improved coatings for use with such optical fibers and optical fiber cables, which can be utilized at temperatures in excess of 300° C. and preferably above 500° C.-600° C. and which are relatively easy to apply, would be advantageous.

### BRIEF DESCRIPTION

Aspects and advantages of the optical fibers and optical fiber cables for use in high temperature applications in accordance with the present disclosure will be set forth in part in the following description, or may be obvious from the description, or may be learned through practice of the technology.

In accordance with one embodiment, an optical fiber for use in high-temperature applications is provided. The optical fiber includes a core, a cladding surrounding the core, a metal coating surrounding the cladding, and a barrier layer surrounding and in direct contact with the metal coating. The barrier layer includes a synthetic metallic grease, the synthetic metallic grease in exemplary embodiments having a thickness of between 20 microns and 200 microns.

In accordance with another embodiment, an optical fiber cable for use in high-temperature applications is provided. The optical fiber cable includes a metallic tube, and at least one optical fiber disposed within the metallic tube. The at least one optical fiber includes a core, a cladding surrounding the core, and a metal coating surrounding the cladding. The optical fiber cable further includes a barrier layer. The barrier layer is at least one of surrounding and in direct contact with the metal coating or coating an inner surface of the metallic tube. The barrier layer includes a synthetic metallic grease, the synthetic metallic grease in exemplary embodiments having a thickness of between 20 microns and 200 microns.

In accordance with another embodiment, an optical fiber for use in high-temperature applications is provided. The optical fiber includes a core, a cladding surrounding the core, a metal coating surrounding the cladding, and a barrier layer surrounding and in direct contact with the metal coating. The barrier layer includes boron nitride. The barrier layer is a dried film on the metal coating, in exemplary embodiments having a thickness of between 2 microns and 20 microns.

In accordance with another embodiment, an optical fiber cable for use in high-temperature applications is provided. The optical fiber cable includes a metallic tube, and at least one optical fiber disposed within the metallic tube. The at least one optical fiber includes a core, a cladding surrounding the core, and a metal coating surrounding the cladding. The optical fiber cable further includes a barrier layer. The barrier layer is at least one of surrounding and in direct contact with the metal coating or coating an inner surface of the metallic tube. The barrier layer includes boron nitride. The barrier layer is a dried film, in exemplary embodiments having a thickness of between 2 microns and 20 microns.

These and other features, aspects and advantages of the present optical fibers and optical fiber cables for use in high temperature applications will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION

A full and enabling disclosure of the present optical fibers and optical fiber cables for use in high temperature applications, including the best mode of making and using the present systems and methods, directed to one of ordinary skill in the art, is set forth in the specification, which makes reference to the appended figures, in which:

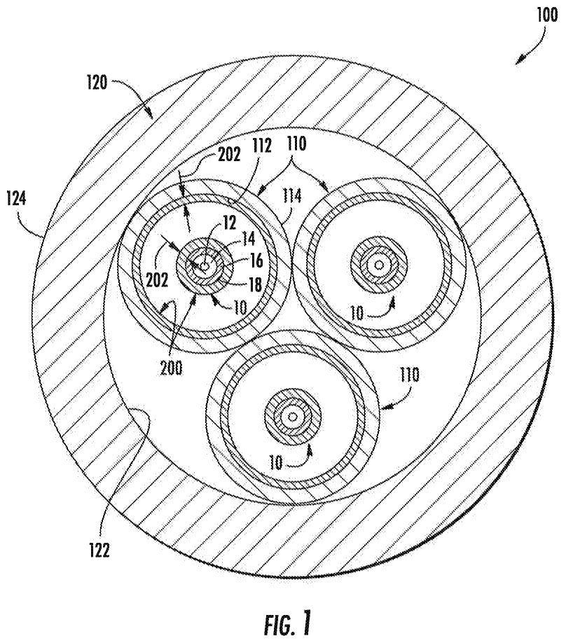

FIG. 1 is a cross-sectional diagrammatic view of an optical fiber cable, including multiple optical fibers in a metallic outer pipe, in accordance with embodiments of the present disclosure;

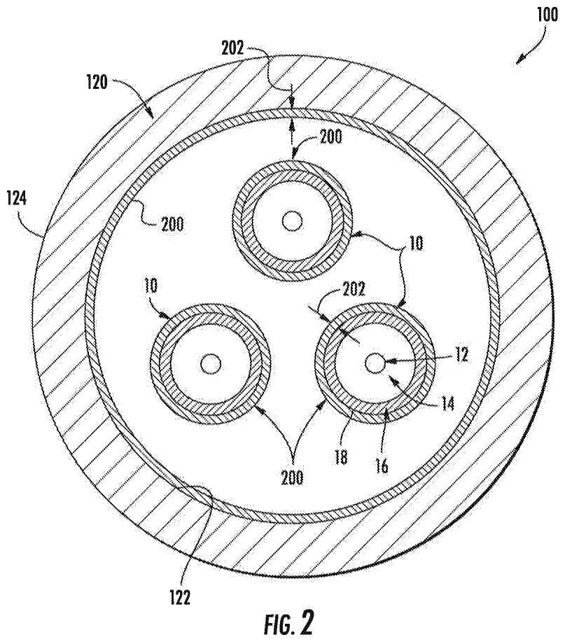

FIG. 2 is a cross-sectional diagrammatic view of an optical fiber cable, including multiple optical fibers each in a metallic buffer tube, the metallic buffer tubes in a metallic outer pipe, in accordance with embodiments of the present disclosure;

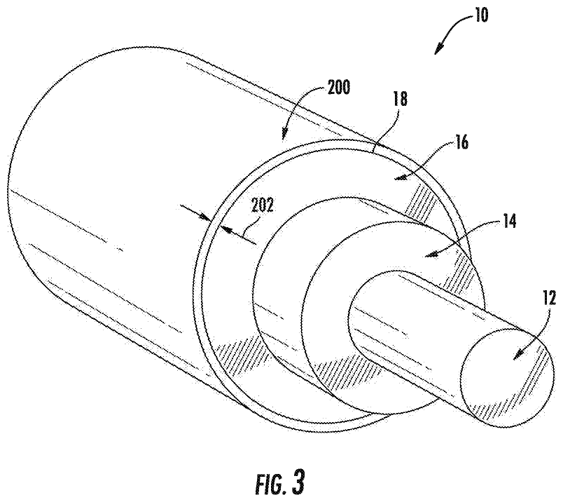

FIG. 3 is a perspective diagrammatic view, with various layers cut away, of a metal-coated optical fiber in accordance with embodiments of the present disclosure.

### DETAILED DESCRIPTION

Reference now will be made in detail to embodiments of the present optical fibers and optical fiber cables for use in high temperature applications, one or more examples of which are illustrated in the drawings. Each example is provided by way of explanation, rather than limitation of, the technology. In fact, it will be apparent to those skilled in the art that various modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component. terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Referring now to FIGS. 1 through 3, embodiments of optical fibers 10 and optical fiber cables 100 for use in high-temperature applications are provided. Such optical fibers 10 and optical fiber cables 100 can advantageously be utilized at temperatures in excess of 300° C., and in exemplary embodiments in excess of 500° C.-600° C., with reduced or eliminated risk of inter-diffusion and/or fusion. Such optical fibers 10 and optical fiber cables 100 utilize barrier layers which the present inventors have discovered are particularly advantageous for such high-temperature applications. For example, the barrier layers as discussed herein advantageously reduce or eliminate inter-diffusion and/or fusion between the optical fibers 10 and any metallic tubes surrounding the optical fibers 10 when being utilized in such high temperature applications. Further, such barrier layers are relatively easy to apply and do not negatively affect other steps in the optical fiber and cable forming process, such as welding steps.

Referring now to FIG. 3, one embodiment of an optical fiber 10 in accordance with the present disclosure is provided. An optical fiber 10 may include a core 12 and a cladding 14 surrounding the core 12. In exemplary embodiments, the core 12 and cladding 14 may be formed from glass (e.g. silica) although in alternative embodiments other suitable materials may be utilized. The optical fiber 10 may in some embodiments be a single-mode optical fiber. In these embodiments, the core 12 may, for example, have a diameter between 5 microns and 10 microns, and the cladding 14 may have a diameter of about 125 microns. Alternatively, the optical fiber 10 may in some embodiments be a multi-mode optical fiber. In these embodiments, the core 12 may, for example, have a diameter between 50 microns and 100 microns, and the cladding 14 may have a diameter of about 125 microns. Alternatively, other suitable core 12 and/or cladding 14 diameters may be utilized, and/or other suitable optical fiber 10 types may be utilized.

A metal coating 16 surrounds and contains the cladding 14 and core 12 of the optical fiber 10. In some embodiments, the metal coating 16 may be provided in direct contact with and on an outer surface of the cladding 14. In alternative embodiments, an intervening layer (which may, for example, be carbon) may be disposed between the cladding 14 and metal coating 16. The metal coating 16 may extend along the entire axial length of the fiber 10.

In exemplary embodiments, the metal coating 16 is a gold coating. Alternatively, other suitable metals, such as nickel, copper, silver, aluminum, ruthenium, rhodium, platinum, or suitable alloys thereof, may be utilized. Metal coating 16 may include a single layer or multiple layers of metal(s) and/or alloys thereof.

Referring now to FIGS. 1 and 2, embodiments of optical fiber cables 100 in accordance with the present disclosure are provided. One or more optical fibers 10 may be included in an optical fiber cable 100. In some embodiments, as illustrated in FIG. 2, one or more optical fibers 10 may be disposed within and surrounded by a buffer tube 110. Each buffer tube 110 may include an inner surface 112 and an outer surface 114, as shown. In some embodiments, one or more buffer tubes 110 (each of which may contain one or more optical fibers 10) may be disposed within and surrounded by an outer pipe 120. The outer pipe 120 may include an inner surface 122 and an outer surface 124. In alternative embodiments, as illustrated in FIG. 1, one or more optical fibers 10 may be disposed within and surrounded by an outer pipe 120, with no intervening tubes (such as buffer tubes 110) between the outer pipe 120 and the optical fibers 10.

A cable 100 in accordance with the present disclosure may include one or more outer pipes 120, each of which may include one or more optical fibers 10 and, optionally, one or more buffer tubes 110. The outer pipes 120 may be arranged in suitable patterns or annular layers as necessary per application.

Outer pipe 120 and buffer tubes 110 in accordance with the present disclosure may in exemplary embodiments be formed from a metal. Suitable metals include, for example, stainless steel, Inconel, Incoloy, etc.

Accordingly, optical fibers 10 in accordance with the present disclosure are in exemplary embodiments disposed within metallic tubes, which may be buffer tubes 110 or outer pipes 120.

Referring again now to FIGS. 1 through 3, a barrier layer 200 may be provided in accordance with embodiments of the present disclosure. The barrier layer 200 may provide a barrier and interface between the optical fibers 10 and metallic tube to reduce or eliminate inter-diffusion and/or fusion as discussed herein. In some embodiments, a barrier layer 200 may be provided on the optical fiber 10, such as on an outer surface 18 of metal coating 16. Accordingly, the barrier layer 200 may surround and be in direct contact with the metal coating 16. Additionally or alternatively, the barrier layer 200 may coat an inner surface of the metallic tube, such as inner surface 112 or inner surface 122. In some exemplary embodiments, the coating may have a particular beneficial thickness, as discussed herein. However, in alternative embodiments other thicknesses may be utilized, and/or the barrier layer 200 may partially or entirely fill the metallic tube.

The present inventors have discovered two particular barrier coating compositions which advantageously provide the desired characteristics in high-temperature applications as discussed herein. Notably, the present discovery and inventive solution as discussed herein, namely the application of such barrier coatings resulting in the various significant advantages as discussed herein, address and solve long-felt yet unmet needs in the fiber optics industry, and in particular in the high-temperature application fiber optics industry. Such discovery and inventive solution is particularly notable due to the attempts and failures to address such long-felt needs by others in the fiber optics industry.

In exemplary embodiments, for example, the barrier layer 200 may thus be or include a synthetic metallic grease. In these embodiments, the barrier layer 200 is applied to a surface as discussed above, such as the outer surface of metal coating 16, inner surface 112, and/or inner surface 122, by for example brushing, dipping, flowing, or another suitable application process. The present inventors have discovered that such barrier layer 200 in exemplary embodiments having a thickness 202 of between 20 microns and 200 microns, such as between 25 microns and 150 microns, such as between 50 microns and 100 microns, such as between 75 microns and 90 microns, such as between 80 microns and 85 microns, is particularly advantageous for use in subject high temperature applications.

In exemplary embodiments, the synthetic metallic grease includes at least one polyolefin. In one embodiment, the grease may include at least two polyolefins. In general, the polyolefin is synthesized from an olefin monomer, such as an α-olefin monomer. In this regard, in one embodiment, the polyolefin may be a poly(α-olefin). The olefin monomer, in particular α-olefin monomer, may include those as generally known in the art. For instance, the olefin monomer may have 2 or more, such as 3 or more, such as 4 or more, such as 5 or more, such as 6 or more, such as 7 more, such as 8 or more carbon atoms. The olefin monomer may have 20 or less, such as 18 or less, such as 16 or less, such as 14 or less, such as 12 or less, such as 11 or less, such as 10 or less, such as 8 or less, such as 6 or less, such as 4 or less, such as 3 or less carbon atoms. Examples of the olefin monomer may include, but are not limited to, ethylene propylene, 1-butene, 3-methyl-1-butene, 3,3-dimethyl-1-butene, 1-pentene, 1-hexene, 1-heptene, 1-octene, 1-nonene, 1-decene, 1-dodecene, etc., and mixtures thereof. It should be understood that some of these olefin monomers may include one or more methyl, ethyl or propyl substituents.

Furthermore, the polyolefin may be a homopolymer or a copolymer. In one embodiment, at least one polyolefin may be a copolymer. If utilized as a copolymer, any of the aforementioned olefin monomers may be utilized in combination to form the copolymer. Typically, with copolymers, at least one monomer may be ethylene, propylene, or butylene (i.e., butene).

In one particular embodiment, the polyolefin may be a homopolymer. The homopolymer may be formed from any olefin monomer, including those mentioned above. For instance, in one embodiment, the polyolefin may include at least one formed from an olefin monomer having a relatively higher number of carbon atoms, such as 6 or more, such as 8 or more, such as 10 or more carbon atoms. In this regard, in one embodiment, the polyolefin may be formed from 1-decene to provide polydecene. In general, because of its longer carbon chains, such polyolefins may be referred to as a base oil. In another embodiment, the polyolefin may include at least one formed from an olefin monomer having a relatively lower number of carbon atoms, such as 5 or less, such as 4 or less carbon atoms. In this regard, in one embodiment, the polyolefin may be formed from 1-butene to provide polybutene. Furthermore, as indicated above, the grease may include at least two polyolefins. In this regard, the grease may include at least one polyolefin formed from an olefin monomer having a relatively higher number of carbon atoms and at least one polyolefin formed from an olefin monomer having a relatively lower number of carbon atoms. In this regard, the grease may include a mixture of polydecene and polybutene.

In addition to the above, in one embodiment, the polyolefin may be hydrogenated. Such hydrogenation may be conducted according to methods known in the art. In this regard, in one embodiment, the polydecene may be a hydrogenated form and/or produced using at least some hydrogenated monomer.

The synthetic metallic grease may further include synthetic graphite and/or a suitable metal powder, such as copper powder. In exemplary embodiments, the barrier layer, such as the synthetic metallic grease thereof, has a specific gravity of between 0.90 and 0.95, such as between 0.91 and 0.94, such as between 0.92 and 0.93. In exemplary embodiments, the barrier layer, such as the synthetic metallic grease thereof has a viscosity of between 40 cSt and 50 cSt, such as between 42 cSt and 48 cSt, such as between 45 cSt and 47 cSt, at @ 100° C.

In addition to the above-stated advantages, the present inventors have surprisingly discovered that the use of synthetic metallic grease advantageously helps to stabilize excess fiber length (“EFL”) during cable processing. For example, with many known materials, EFL is lost during processing of the cable. Such is not the case with synthetic metallic grease. To the contrary, the grease maintains the fibers in the cables during processing such that EFL does not protrude from the cable (which would make the EFL unrecoverable). Further, the present inventors have discovered that the EFL remains generally uniform throughout such cables even when heated to high temperatures as discussed herein, and still further when the cables are then cooled to room temperature.

In other embodiments, for example, the barrier layer 200 may thus be or include a boron nitride. In exemplary embodiments, the barrier layer 200 is a lubricant. Boron nitride exists in a variety of different crystalline forms (e.g., h-BN—hexagonal, c-BN—cubic or spharlerite, and w-BN—wurtzite), any of which can generally be employed in accordance with the present disclosure.

In these embodiments, the barrier layer 200 is applied to a surface as discussed above, such as the outer surface 18 of metal coating 16, inner surface 112, and/or inner surface 122, by for example brushing, dipping, spraying, flowing, or another suitable application process. The barrier layer 200 as applied is a dried film on the subject surface. The present inventors have discovered that such barrier layer 200 in exemplary embodiments having a thickness 202 of between 2 microns and 20 microns, such as between 2 microns and 10 microns, such as between 3 microns and 7 microns, is particularly advantageous for use in subject high temperature applications.

The boron nitride barrier layer in accordance with the present disclosure is advantageously non-flammable. In exemplary embodiments, a fired composition of the barrier layer, such as the boron nitride thereof, in air at 700 degrees Celsius is greater than 95% boron nitride. In exemplary embodiments, the barrier layer, such as the boron nitride thereof, has a specific gravity of between 1.30 and 1.35, such as between 1.31 and 1.34, such as 1.32.

In exemplary embodiments, the barrier layer, such as the boron nitride lubricant thereof, includes a binder phase. In some embodiments, the binder phase may include a silicate (which may be natural or synthetic), such as a metal silicate. Suitable metals include alkali metals, alkaline earth metals, transition metals, etc. For example, aluminum, iron, sodium potassium, magnesium, and calcium are suitable examples. In exemplary embodiments, the barrier layer includes a magnesium silicate binder phase.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An optical fiber for use in high-temperature applications, the optical fiber comprising:
a core;
a cladding surrounding the core;
a metal coating surrounding the cladding; and
a barrier layer surrounding and in direct contact with the metal coating, the barrier layer comprising a synthetic metallic grease, the synthetic metallic grease having a thickness of between 20 microns and 200 microns.

2. The optical fiber of claim 1, wherein the synthetic metallic grease comprises a synthetic hydrocarbon base oil.

3. The optical fiber of claim 2, wherein the synthetic hydrocarbon base oil comprises 1-decene.

4. The optical fiber of claim 1, wherein the barrier layer has a specific gravity of between 0.90 and 0.95.

5. The optical fiber of claim 1, wherein the barrier layer has a viscosity of between 40 cSt and 50 cSt at @ 100° C.

6. The optical fiber of claim 1, wherein the thickness is between 75 microns and 90 microns.

7. The optical fiber of claim 1, wherein the metal coating is a gold coating.

8. The optical fiber of claim 1, wherein the optical fiber is a single-mode optical fiber.

9. The optical fiber of claim 1, wherein the optical fiber is a multi-mode optical fiber.

10. An optical fiber cable for use in high-temperature applications, the optical fiber comprising:
a metallic tube;
at least one optical fiber disposed within the metallic tube, the at least one optical fiber comprising:
a core;
a cladding surrounding the core; and
a metal coating surrounding the cladding; and
a barrier layer, the barrier layer at least one of surrounding and in direct contact with the metal coating or coating an inner surface of the metallic tube, the barrier layer comprising a synthetic metallic grease, the synthetic metallic grease having a thickness of between 20 microns and 200 microns.

11. The optical fiber cable of claim 10, wherein the metallic tube is a buffer tube.

12. The optical fiber cable of claim 11, further comprising an outer pipe surrounding the buffer tube, the outer pipe formed from a metal.

13. The optical fiber cable of claim 10, wherein the metallic tube is an outer pipe, and wherein there are no intervening tubes between the at least one optical fiber and the outer pipe.

14. The optical fiber cable of claim 10, wherein the synthetic metallic grease comprises a synthetic hydrocarbon base oil.

15. The optical fiber cable of claim 14, wherein the synthetic hydrocarbon base oil comprises 1-decene.

16. The optical fiber cable of claim 10, wherein the barrier layer has a specific gravity of between 0.90 and 0.95.

17. The optical fiber cable of claim 10, wherein the barrier layer has a viscosity of between 40 cSt and 50 cSt at 100° C.

18. The optical fiber cable of claim 10, wherein the thickness is between 75 microns and 90 microns.

19. The optical fiber cable of claim 10, wherein the metal coating is a gold coating.
